(19) United States
(12) Patent Application Publication
(10) Pub. No.: US 2016/0132804 A1
(43) Pub. Date: May 12, 2016

(54) SYSTEM AND METHOD FOR CONTINUOUSLY PLANNING MAINTENANCE OF ENTERPRISE EQUIPMENT

(71) Applicant: COPPERLEAF TECHNOLOGIES INC., Burnaby (CA)

(72) Inventors: Lawrence CROFT, Burnaby (CA); Giuseppe GNOCATO, Coquitlam (CA); Stanley Thomas COLEMAN, North Vancouver (CA); Simon Nesbitt HORNER, West Vancouver (CA)

(21) Appl. No.: 14/536,585

(22) Filed: Nov. 7, 2014

(51) Int. Cl. G06Q 10/06

(52) U.S. Cl. CPC G06Q 10/06313

(57) ABSTRACT

Systems and methods for continuously planning maintenance of enterprise equipment are provided. Draft forecasts relating to projects in an infrastructure are generated by a computer system. A first user (U1) selects a draft forecast and submits it for approval. The computer system adds the submitted forecast to a submitted scenario. A second user (U2) approves or rejects the submitted forecast for inclusion in a master scenario. The second user may modify the submitted forecast. The system permits continuous planning of projects to maintain an enterprise infrastructure.

### FIELD

This invention relates to maintaining and improving infrastructure in enterprises such as electrical power utilities, pipelines, municipal infrastructure, and the like. Example embodiments provide machine-implemented methods useful for establishing, maintaining, and executing plans for infrastructure maintenance and improvement as well as apparatus useful for managing upkeep and improvement of infrastructures.

### BACKGROUND

Many enterprises rely on infrastructures made up of a large number of pieces of equipment and other infrastructure components which function together to yield some result. For example, an electrical power utility may deliver power through a network made up of generators of various kinds, electrical transformers, electrical switchgear, electrical transmission lines and their components (towers, utility poles, wires, insulators, etc.), control systems, substations, monitoring equipment, maintenance equipment, and the like.

As another example, a natural gas utility may deliver natural gas to consumers by way of a system made up of gas wells, networks of pipelines, compressing stations, valves, pressure regulators, monitoring equipment, control equipment, maintenance equipment, and the like. Many other examples also exist. For example, water distribution systems in cities, factories, cable television systems, port operations, railways, and other enterprises all rely on infrastructures made up of large numbers of pieces of equipment or other physical infrastructure components to perform their operations.

Most, if not all, equipment and other elements of physical infrastructure tend to degrade over time. As a result of such degradation, failures can become more likely. As failures become more likely, the risks of consequences associated with the failures also become higher. “Failure risk” for an infrastructure component combines the probability that the component will fail and a measure of the consequence of failure of the component. Failure risk may be represented by a pair of values {P,C} where P is probability of failure and C is consequence of the failure or as a single value which is a function of probability and consequence of the failure.

While it is conceivable that an enterprise could function by ignoring proactive maintenance and could simply respond to failures as they occur by fixing or replacing any failed infrastructure component(s), this approach is undesirable in almost all circumstances because it allows the infrastructure to deteriorate to the point that it becomes unreliable. Additionally, this approach does not facilitate informed budgeting for the cost of maintaining the enterprise. Moreover, it may leave the enterprise in a situation where for some period of time there are more failures than the enterprise can accommodate. For example, the enterprise may not have enough manpower or specialized equipment to address more than a certain amount of failures in any one period.

For this reason, many enterprises attempt to proactively maintain and upgrade and replace elements of their infrastructure. In large enterprises, a program of proactive upgrading maintenance and replacement may involve a very large number of projects. Each of these projects will typically be scheduled to occur on a timeline between a start date and an end date.

Scheduling individual projects may be subject to various constraints. For example, maintaining a particular dam may need to be done at particular times of year when the water level behind the dam is low. There may be a link between two or more projects which makes them particularly cost-effective if done together. For example, equipment needed to complete one project at a site may also be used to complete another project at the same site without the need to transport the equipment to the site twice. Some projects may need to be completed in a certain order. For example, if one project involves replacement of a utility pole and another project involves replacement of a transformer carried by the utility pole, it would make most sense to replace the utility pole first and to replace the transformer second. In some cases, larger constraints may limit the number of projects that may be completed at one time. For example, certain projects may require specialized equipment and/or a specialized workforce to complete. Either of these may be in limited supply. As another example, there may be limited financial resources to apply to projects within a certain timeframe.

For any or all of these reasons, establishing a plan as to exactly which projects are going to be completed in which order and when can be very complicated, especially for a large enterprise which may have complicated infrastructure which requires an exceedingly large number of projects to maintain the infrastructure in reliable operating condition. Many such enterprises must plan operations in such a way as to provide continued service with few or no interruptions. Failing to appropriately plan and execute the repair and replacement of infrastructure components may render the infrastructure unreliable and/or dangerous.

Scenarios can be a useful planning tool. An organization may establish a scenario for proposed projects in some timeframe (e.g. the next year, the next two years, the next five years, etc.) Such scenarios may be used for scheduling of manpower and equipment; budgeting, and risk assessment to give a few examples. Such scenarios may be analyzed to ensure that an aggregate failure risk for the infrastructure will be kept at a suitably low level and that completion of the tasks proposed in the scenario is feasible.

A computer system may be configured to calculate various things from a scenario. For example, information about the projects may be processed to yield an indication of the workforce required as a function of time to complete the projects and/or the amount of equipment or other resources that may be required as a function of time to complete the projects on the schedule proposed in the scenario. As another example, from budgets associated with each scheduled project, a computer system may process a scenario to yield an indication of the amount of spending as a function of time that would occur if the proposed projects went ahead according to the schedule proposed in the scenario.

A further complication is that certain projects may need to be completed before certain dates. For example, certain systems may become obsolete. An enterprise may be forced to upgrade or replace such systems before parts or other services become unavailable, especially where the system is being applied in a mission critical application. In addition, failure of certain systems may have potentially very bad consequences such as the potential for harming or killing people or the environment or causing extreme consequential damage to other infrastructure. It may be necessary to upgrade or replace such systems before the condition of the systems deteriorates to the point where the risk or such catastrophic harm is greater than some small threshold. In some industries government regulation also may mandate that certain projects be completed on a particular schedule.

For at least the reasons above, arriving at a scenario, which may be treated as a master plan, that optimally schedules a large number of projects in such a way that keeps the risk of the consequences of failures desirably low while also respecting the various constraints that apply to scheduling the projects can be very difficult. For these and other reasons, enterprises generally use computer systems to establish, assess, and implement scenarios, particularly in large enterprises with large infrastructures having many potential projects. As the power of computer systems has grown, the scale and complexity of plans established and assessed by such computer systems have also grown. A single scenario established by a computer system may have hundreds, thousands, tens of thousands, or even more projects.

It is often necessary to tweak or adjust a scenario to reduce risk and/or take advantage of synergies between different projects and/or satisfy a constraint regarding the availability of equipment, manpower, or budget, and/or adapt to changes, etc. This exercise may result in a number of scenarios that are modified relative to one another. Modified scenarios may also result when different scenarios are created with different goals in mind For example, creating a scenario which would cut the risk of damage to the environment in half for an enterprise might yield a different ordering and timing of projects than a scenario which must be completed within a specified reduced budget. These two scenarios might differ in turn from another scenario which is directed to increasing the production capacity of the enterprise for some particular output period.

Accordingly, there is a need for computer systems which can assist in the development, maintenance, and execution of scenarios for completing the projects required to maintain a complicated infrastructure in an effective way. There is a particular need for such systems which permit multiple users to work together using and modifying such scenarios and their component projects with a minimum of conflict.

In a large enterprise, different people and/or departments may be responsible for different parts of the enterprise's infrastructure. For example, an enterprise may have various divisions which each manage a certain portion of the enterprise infrastructure. These divisions may be divided geographically, by function, or in some other way. Detailed knowledge of the interrelationships between various projects and the changes in condition that may result in a need to reorganize a previously proposed schedule for proceeding with projects may exist at a lower level within the enterprise. However, the enterprise may need to maintain a central control and planning function which manages the overall operation of the enterprise.

It may be desirable to use scenarios to organize the planning of projects across an entire enterprise or over a large portion of an enterprise's operations. Such scenarios may include all infrastructure related projects as currently proposed for purposes such as resource allocation within the enterprise, budgeting, and the like. Generating such scenarios may require the cooperation of many different parts of the enterprise, particularly when computer systems are used to generate complex scenarios that describe the operation of many different responsible parts of a large enterprise with any significant detail. This objective may be frustrated, however, if it is not possible to smoothly integrate into a scenario changes arising from various responsible parts of the enterprise. There is a need for systems and methods which permit localized management of projects while also facilitating enterprise-wide management of the projects.

### SUMMARY

This invention has a number of aspects. Some aspects provide machine-assisted methods for planning maintenance to enterprise infrastructure and/or initiating projects to maintain and improve enterprise infrastructure. In some embodiments, planning comprises generating project forecasts that correspond to planned projects for replacing, refurbishing or upgrading infrastructure components. A master scenario contains versions of project forecasts that have been approved, either with or without modification.

New versions of project forecasts may be submitted, for example in response to changing conditions affecting the infrastructure. The new versions are processed by an approval system which determines whether or not the new versions are accepted for inclusion in the master scenario. Since new versions are not automatically incorporated into the master scenario, a supervisory user can work with the master scenario without having the master scenario undergoing unexpected changes. Other users may continue to submit new versions of project forecasts which take into account changing conditions. The system may indicate to the user those project forecasts in the master scenario for which there is a more-recent but not-yet-accepted version. The supervisory user may modify project forecasts in the master scenario. Users who submitted these project forecasts may be notified automatically of the modifications.

One example aspect provides a method for planning projects for maintaining an infrastructure. The method is implemented by a computer system. The method comprises receiving a plurality of submissions of new versions of project forecasts. Each of the project forecast is associated with a project to act on an infrastructure component (e.g. by replacing, upgrading and/or refurbishing the infrastructure component). The submissions are initiated by one or more first users of the computer system. There may be a plurality of the first users each responsible for a different part of the infrastructure. The method presents a user interface that provides a second user with options including: rejecting the new version of the project forecast and accepting the new version of the project forecast for each of the submitted new versions. The method incorporates the accepted new versions into a master scenario.

In some embodiments the method comprises, for one or more of the submitted new versions, determining that one or more modifications have been applied to a corresponding current version of the project forecast in the master scenario and, for the one or more of the submitted new versions, providing the second user with the option to incorporate the new project forecast as modified by the one or more modifications in the master scenario in place of the current version of the project forecast.

In some embodiments the method comprises automatically updating a submitted scenario to include the submitted new versions in place of corresponding current versions of the project forecasts. The submitted and master scenario may be compared in a display provided by the computer system.

Another example aspect provides a method for planning projects for maintaining an infrastructure. The method is implemented by a computer system and comprises receiving submission initiated by a first user of a new version of a project forecast associated with a project to replace, upgrade and/or refurbish an infrastructure component. The method determines that one or more modifications have been applied to a current version of the project forecast in a master scenario. This determination may comprise retrieving recorded information logging changes that have been made to project forecasts. In response to input from a second user, the method applies the one or more modifications to the new project forecast and incorporates the new project forecast as modified by the one or more modifications in the master scenario in place of the current version of the project forecast.

Another example aspect provides a system useful for planning projects for maintaining an infrastructure. The system comprises a plurality of first user environments in data communication with a database. The database stores records corresponding to each of a plurality of project forecasts. The project forecasts each specify a project to replace, upgrade and/or refurbish an infrastructure component. The database comprises associations grouping project forecasts into scenarios. The scenarios include at least a master scenario. Each of the first user environments comprises a data processor configured to generate submissions of new versions of the project forecasts. These submissions may be initiated by users of the first user environments. An approval system is connected to receive the submissions. The approval system presents a user interface that provides a second user with options for processing the submissions including: rejecting the new version of the project forecast and accepting the new version of the project forecast for each of the submitted new versions. The approval system is configured to incorporate accepted ones of the new versions into the master scenario.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is schematic illustration of a computer system according to an example embodiment of the invention.

FIG. 2 is a schematic illustration of an example implementation of the embodiment of FIG. 1 according to a three-tier structure.

FIG. 3 is a flowchart illustrating a method according to an example embodiment.

FIG. 4 is an entity relationship drawing illustrating a database structure according to an example embodiment.

FIG. 5 is an example user interface for viewing scenarios according to an example embodiment.

FIG. 6A illustrates a hierarchy for organizing various projects in a scenario according to an example embodiment.

FIG. 6B illustrates a hierarchy for organizing various projects in a scenario according to another example embodiment.

FIG. 6C illustrates a hierarchy for organizing various projects in a scenario according to yet another example embodiment.

FIG. 7 illustrates an example user interface for viewing projects in a scenario according to an example embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

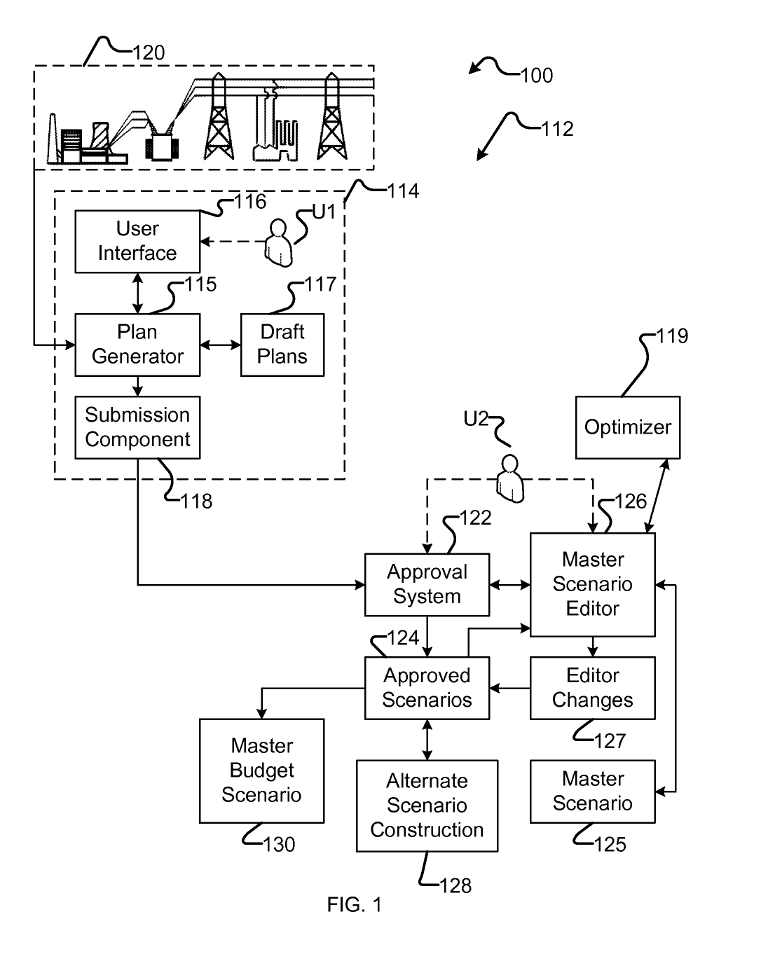

FIG. 1 illustrates schematically a system according to an example embodiment of the invention. System 100 comprises a computer system 112, which may be centralized or distributed. Computer system 112 provides one or more project initiation environments 114. Each project initiation environment 114 comprises a plan generator 115 which permits creation and adjustment of plans for projects which will affect components of an infrastructure 120.

In some embodiments, plan generator 115 is populated with information identifying individual components of infrastructure 120 as well as information relevant to the physical condition of those infrastructure components. Plan generator system 115 comprises a user interface 116 which enables a user to initiate projects affecting infrastructure components and to modify those projects. For example, plan generator 115 may permit a user to schedule a project to replace an infrastructure component or a project to upgrade or refurbish an infrastructure component. Parameters for a given project may be based on information relating to components of infrastructure 120 affected by the project. For example, parameters for a given project may be based on a current condition and/or an estimated future condition of a particular component of an infrastructure 120. A plan generated by plan generator 115 may be called a “project forecast” or simply a “forecast”.

A project forecast may, for example, describe the resources and costs required to implement a plan for maintaining, improving, or otherwise dealing with a component in infrastructure 120. For example, a transformer replacement project may have an associated forecast describing costs on the order of $2 million, a specified start date and a specified end date. The forecast may further describe the monthly cash flow associated with the project, and/or may describe the required resources for completing the project. Such resources may include, for example, internal (e.g. employee) labor, external (e.g. contractor) labor, materials, fiscal overheads, interest payments, and the like.

Draft plans 117 may be stored and retrieved by plan generator 115. A user U1 working by way of user interface 116 may, for example, edit draft plans for any number of infrastructure related projects by, for example, altering start or end dates for the projects, altering the nature or scope of the projects, and so on. User U1 may be responsible for a large number of projects.

User U1 may, for example, be a person who is well informed regarding the part of infrastructure 120 to which the projects being planned relate as well as the resources available to handle those projects. In response to changes in available resources and changes in circumstances affecting infrastructure 120, user U1 may change one or more draft plans 117 to take into account the changes in circumstances.

Environment 114 also comprises a project forecast submission component 118 which allows user U1 to cause a draft project plan 117 to be submitted as a project forecast to be used in enterprise-wide planning. Submitted draft plans 117 may be incorporated into scenarios which describe multiple plans (e.g. a scenario may comprise forecasts/plans for each project in an infrastructure 120).

An enterprise may have a number of environments 114 available to a range of users U1 all of whom are responsible for a different part of the infrastructure for an enterprise. Project forecasts submitted by all users U1 may be automatically aggregated into a submitted scenario 119. Submitted scenario 119 may be available for review by users across the enterprise in some embodiments.

Computer system 112 also comprises an approval system 122 which allows appropriate user U2 to review and approve or reject submitted project forecasts. As described in more detail below, computer system 112 may send messages to user U1 advising regarding the status of project forecasts submitted by way of submission gateway 118. Approved project forecasts 124 are incorporated into a master scenario 125.

A user U2 may inspect master scenario 125 by way of a master scenario editor 126. User U2 may also be entitled to edit the project forecasts that have been incorporated into master scenario 125, for example, by changing the start or end times of individual projects and/or changing the nature or scope of the projects or by editing any other attribute of the project forecast. Such changes may also, or alternatively, be made to master scenario 125 by master scenario editor 126. When a user U2 changes a project forecast in master scenario 125, computer system 120 may automatically notify the responsible user U1 or others of the changes made to the project forecast.

It can be appreciated that computer system 112 both supports the needs of users, such as user U1, who are immediately responsible for originating and completing projects to be able to propose project forecasts and to adjust those project forecasts in response to developments affecting the infrastructure 120 and/or the resources available to work on that infrastructure 120. System 112 also addresses the needs of a user, such as user U2, who requires the ability to work with master scenario 125 without having the individual project forecasts which belong to master scenario 125 being constantly altered by externally generated changes. Providing a system that provides user U2 with the ability to edit project forecasts directly can significantly streamline project planning. Providing a system which permits user U2 to select which submitted project forecasts to incorporate into master scenario 125 (and in particular allows user U2 to reject some submitted project forecasts while rejecting others) facilitates maintenance of a master scenario that can be continually updated to reflect changes in the infrastructure and changes in surrounding conditions.

Master scenario editor 126 maintains a record of any changes 127 made to approved project forecasts 124 (e.g. by user U2). Advantageously, approval system 122 permits user U2 to view new submitted project forecasts. In some embodiments, approval system 122 provides user U2 with a number of options when a project forecast is submitted. These may include, for example, the options of: rejecting the project forecast, accepting the project forecast and accepting the project forecast with changes.

In most cases submitted project forecasts will be newer versions of project forecasts already present in master scenario 125. In such cases user U2 may be presented with the option of replacing the version of the project forecast that is currently in master scenario 125 with the new project forecast, or with a version of the project forecast that has been modified by incorporating changes that have been made to the current version of the project forecast in master scenario 125 or rejecting the new version of the project forecast, the new draft scenario, accept the new draft scenario, and replace a previously approved version of the new draft scenario with the new draft scenario, or to replace the previously approved version of the new draft scenario with the new draft scenario while automatically applying to the new draft scenario any changes that had been made to the previously approved scenario.

In some embodiments, computer system 120 has an alternative scenario construction system 128 which generates modified versions of master scenario 125. For example, system 128 may generate a version of an approved scenario which is modified to reduce risk (e.g. by replacing infrastructure components having large failure consequences earlier). Another alternative version of the approved scenario may be modified to have a reduced or increased budget. Another version of the approved scenario may be modified to maximize safety, and so on. User U2 may review the modified versions of master scenario 125 prepared by system 128 and compare them to master scenario 125. User U2 may optionally copy one or more project attributes from one or more project forecasts in one of the varied scenarios to master scenario 125.

In some embodiments, system 112 receives information which may affect project forecasts, and in particular may require that master scenario 125 and/or approved project forecasts 124 be varied. For example, for an electrical infrastructure 120, planned and/or unplanned outages of one or more components of infrastructure 120 may be common occurrences. Certain projects may only be possible to complete, or may be preferably completed, during an outage. Further, certain outages (such as unplanned outages) may affect the budget available for some projects, and/or may constrain the available workforce during and/or after the outage.

Accordingly, system 112 may, for example, generate varied scenarios at alternate scenario construction system 128 based on master scenario 125 upon receiving information relating to an outage and/or another event affecting project forecasts in master scenario 125. For example, system 112 may receive information that the schedule for planned outages has changed for the upcoming months. Alternate scenario construction system 128 may generate varied scenarios for approval by user U2 which are based on master scenario 125 but have adjusted project forecasts so that projects which are dependent on outages occurred during the new outage times (and, optionally, other projects may be adjusted to balance workload across outage and non-outage times). Other events include, for example, failure of components of infrastructure 120, weather events, budgetary events (such as an unexpected cost overrun on a project, a legal judgment requiring a payout, lower than expected revenues, etc.), and other events.

In some embodiments, system 112 receives event information (e.g. such as outage information) from systems with which system 112 is integrated. For example, system 112 may be integrated with a sensor system which advises system 112 when certain components of infrastructure 120 experience in outage, a budgetary system which reflects current budgetary constraints, a project management system which reflects current planned events (such as outages), and other systems.

In some embodiments, system 112 provides user U1 with a notification when master scenario 125 and/or approved project forecasts 124 are modified, e.g. by approval by user U2 of a varied scenario generated by alternate scenario construction system 128 and/or by approval by user U2 of a project forecast with changes. Such notifications may be issued if, for example, such modification affects a forecast submitted by user U1. Alternatively, or in addition, user U1 may be notified of modification of a project forecast relating to a project which user U1 has authorization over, even if user U1 has not submitted a forecast relating to that project.

At any point a user U2 of computer system 112 may cause a copy of master scenario 125 to be stored as a master budget scenario 130, which is fixed and not subject to further editing via master scenario editor 126, alternative scenario construction system 128, and/or other means. In some embodiments, master budget scenario 130 is stored in a different part of the memory of computer system 112 from approved scenarios 124, master scenario 125, and/or varied scenarios generated by system 128.

In some embodiments, computer system 112 permits user U1 to compare their most recent project forecasts (or a project forecast that they select) to the version of the project forecast in master scenario 125. For example, user U1 may view comparisons of project forecasts in draft plans 117 to corresponding project forecasts in master scenario 125 at user interface 116.

Computer system 112 may comprise an optimizer 119. Optimizer 119 may be applied to a scenario to compute adjustments to the various project forecasts specified by the scenario. The adjustments may change the start date, change the recommended alternative, and/or change the resources allocated to the project in order to meet the target specified for the optimization. Optimization by optimizer 119 may be based on one or more optimization criteria. For example, optimizer 119 may optimize a scenario based on one or more of: an expected future cost of all or part of the scenario, a failure risk associated with infrastructure components addressed by one or more projects in the scenario, expected future resource requirements of all or part of the scenario (resources may comprise, for example, workforce, machinery, materials, or the like any of which may be in limited supply), required replacement dates for certain infrastructure components (e.g. certain components may need to be replaced by certain dates for compliance with applicable regulations and/or because they will no longer be supported by a manufacturer or the like).

After a master budget scenario 130 has been established, new information may become available. This new information may result in changes of various kinds to the projects contemplated by master budget scenario 130. For example, costs of certain aspects of a project may change as a result of newly discovered problems with an infrastructure component. System 112 may permit comparison of master budget scenario 130 to the currently submitted approved scenarios. For example, master budget scenario 130 may be provided to approval system 122, which may display to users U2 a comparison of the proposed scenarios with the currently accepted master scenario 125 and/or the master budget scenario 130. System 112 may also, or alternatively, provide master scenario 125 and/or master budget scenario 130 to optimizer 119 to assist in the optimization of project forecasts.

In some embodiments, master scenario 125, master budget scenario 130 and/or a submitted scenario are compared to one another and/or to one or more other scenarios using technology as described in commonly-owned co-pending U.S. patent application Ser. No. 14/535,125 filed on Nov. 6, 2014 and entitled APPARATUS AND METHODS FOR FILTERING AND DISPLAYING DIFFERENT SCENARIOS which is hereby incorporated herein by reference for all purposes.

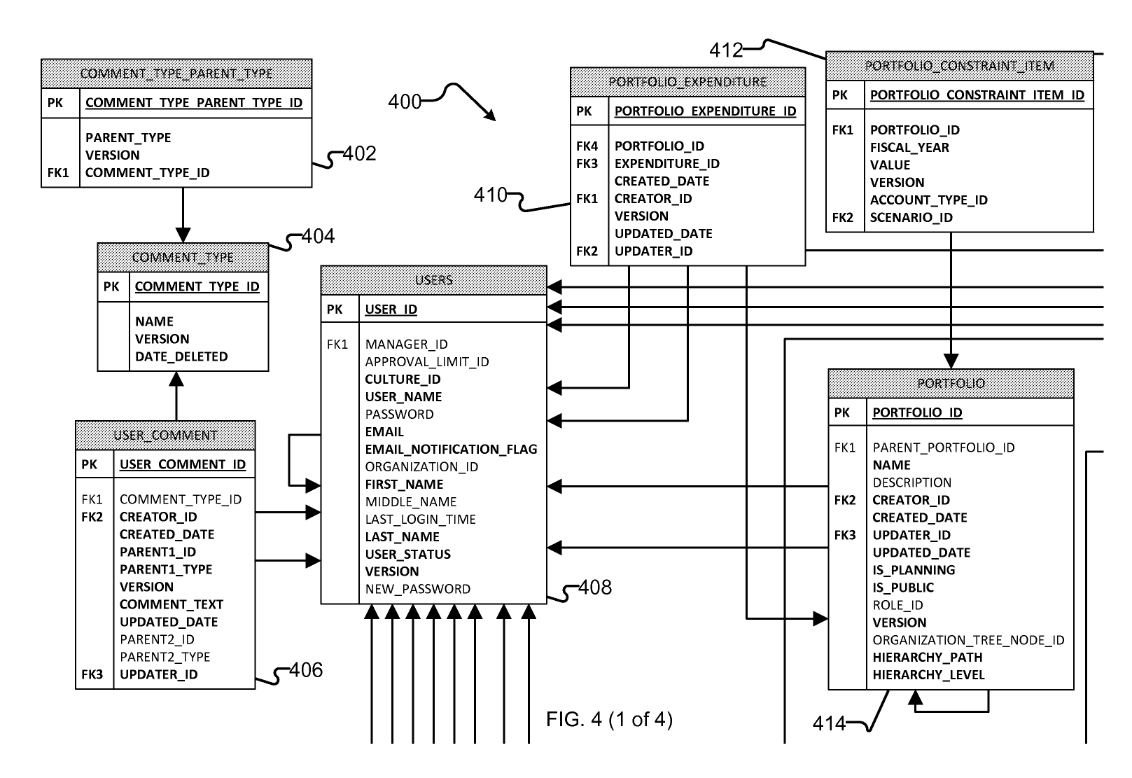

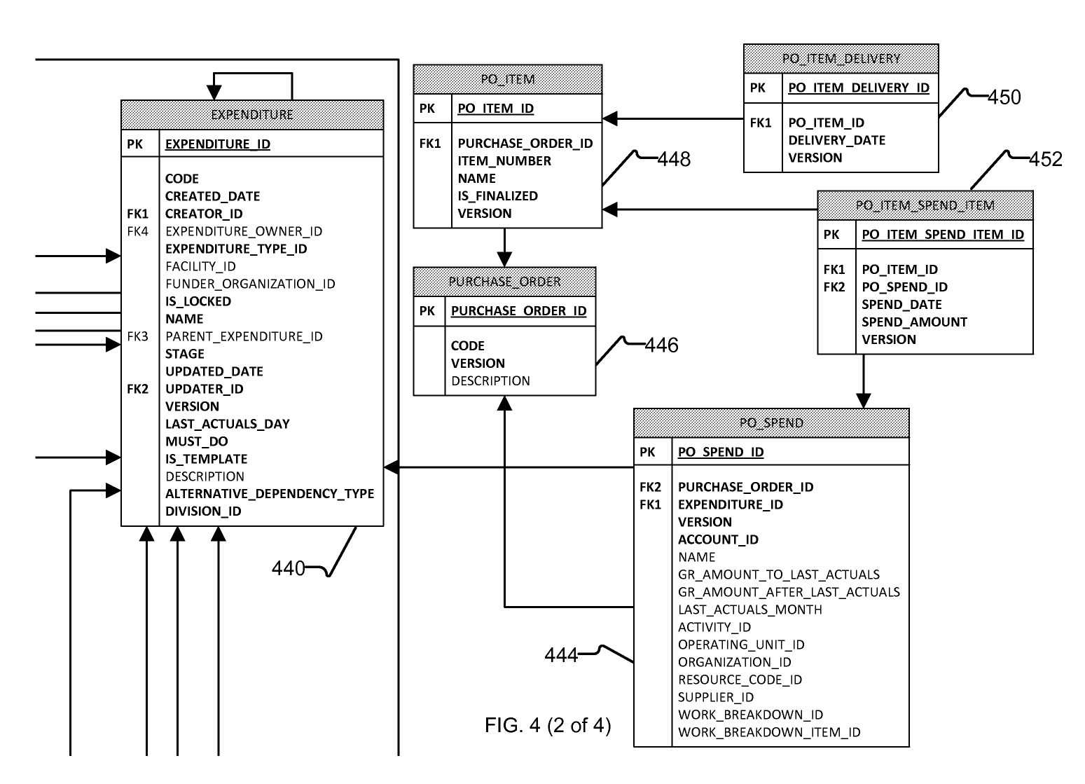

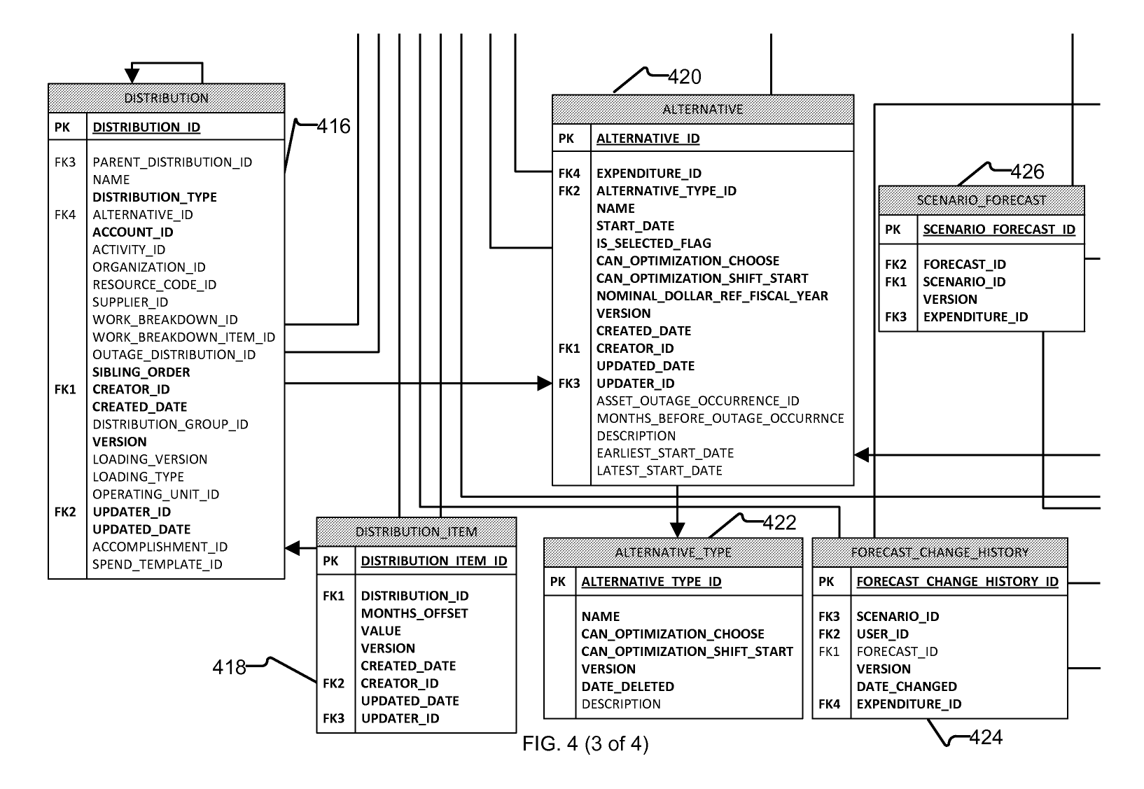

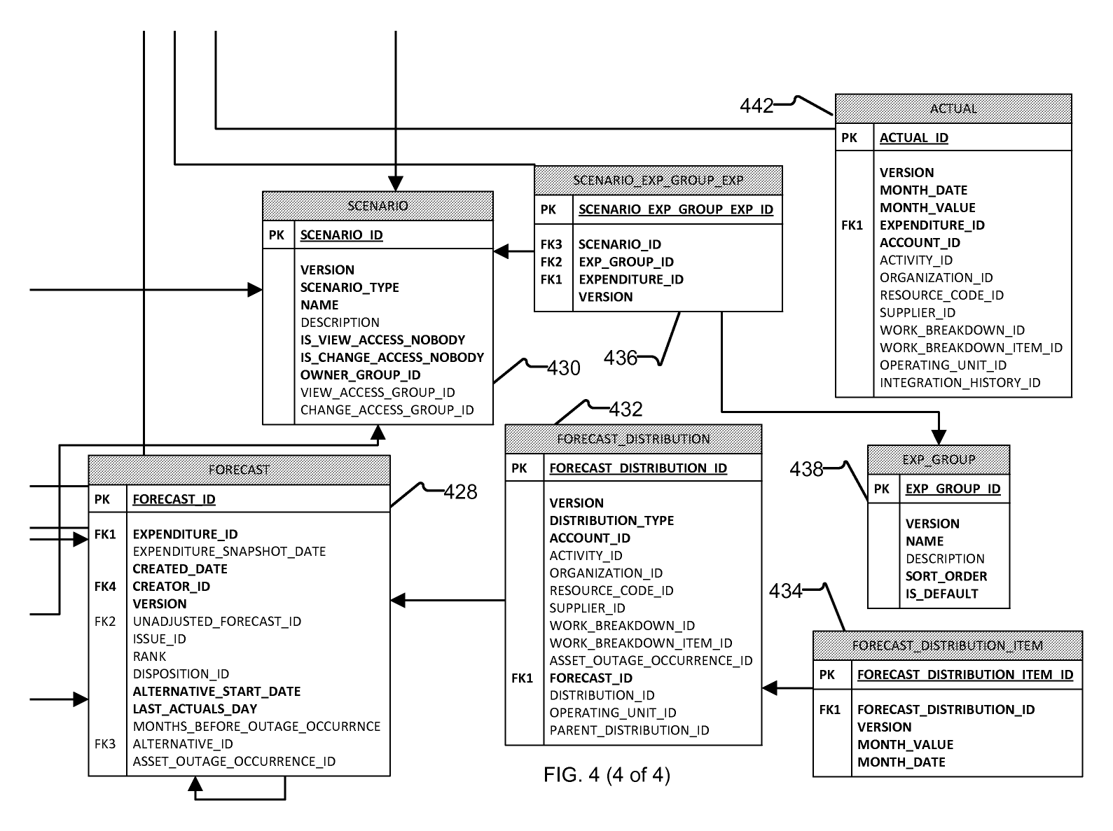

System 112 may be used to plan projects for maintaining and improving an infrastructure, and to store details relating to those projects (e.g. in project forecasts 124, and scenarios 125, and/or 130), as described above. In some embodiments, system 112 also stores details regarding the completion of projects relating to the infrastructure, and may update those details as projects are completed. For example, a project for replacing a group of utility poles may be forecast to complete within a certain budget and within a certain timeframe. System 112 may receive information regarding the actual expenditure associated with replacing the group of utility poles and the actual date by which the utility poles were replaced; this information may be stored by system 112, as described in greater detail below (see, e.g. FIG. 4). In some embodiments, system 112 receives completion information from systems with which system 112 is integrated. For example, system 112 may be integrated with a purchase order system which advises system 112 when purchase orders relating to particular projects are generated and/or when such purchase orders are paid.

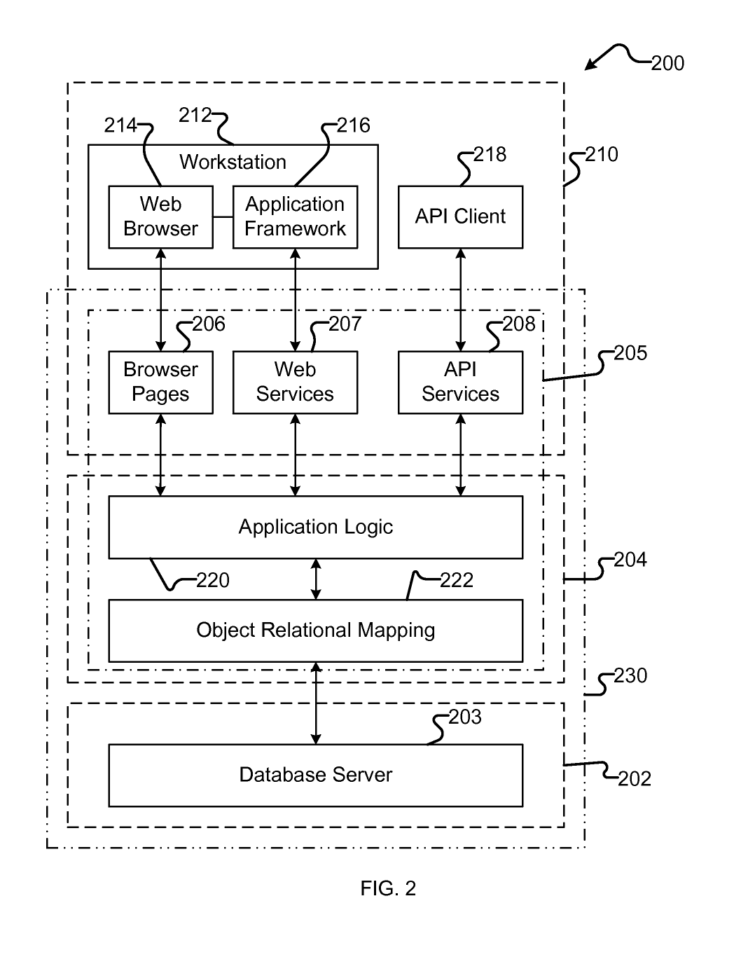

In some embodiments, computer system 112 may be implemented in a three tier structure as illustrated in FIG. 2. System 200 in FIG. 2 includes a persistent data tier 202 which comprises a database server 203, for example an Oracle™ database server. A logic tier 204 comprises a web server 205 which interfaces to database server 203 (e.g. via an object relational mapping 222 interfacing with application logic 220). Web server 205 provides access to database server 203 via browser client pages 206, client web services 207, and/or custom application programming interfaces (APIs) 208 which are included in a presentation and client interface tier 210. Users of workstations 212 may access system 200 by way of a web browser 214 interacting with browser client pages 206 and/or an application framework 216 (e.g. Microsoft Silverlight™ or the like) interacting with client web services 207. Alternatively, or in addition, system 200 may be accessed (e.g. by users, external computer systems, and/or others) by way of API client 218 interacting with APIs 208. In some embodiments, web server 205 and/or database server 203 may be provided in a secure network environment 230. In some embodiments, web server 205 comprises a plurality of servers operating as a cluster.

A computer system 112 or 200 may be used to generate a very large number of different scenarios for the same projects which may differ in terms of the details of how the projects will be executed. For example, different scenarios may differ as to the timing of the project, and the selection of an alternative way to complete the project. For example, one alternative included in a project forecast may be to replace an infrastructure component. Another alternative way to complete the project may be to refurbish the infrastructure component. The project forecast may include an alternative in which the infrastructure component is refurbished. Another way project forecasts may be adjusted is to change the mode of execution of the project. For example, the amount of resources directed to the project may be changed.

A computer system being used to track components of a large infrastructure and to organize projects relating to those infrastructure components could create an unmanageably large amount of data. In some embodiments, the amount of data being managed by the computer system is controlled by maintaining pointers to versions of projects rather than copying all versions of projects when a new scenario is created from a previous scenario. Each time a project forecast is submitted for approval a new version of the project forecast in the scenario may be created.

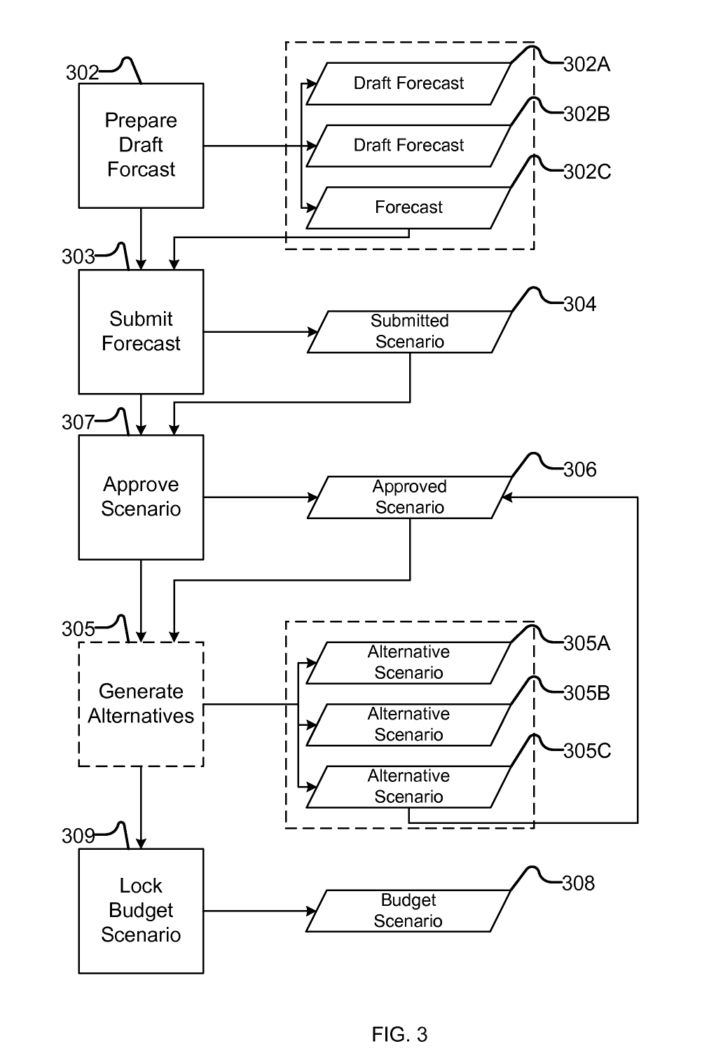

FIG. 3 illustrates a process flow that may be performed using systems according to some embodiments of the invention. At step 302, the system prepares a project forecast 302C for a project. The system may prepare forecast 302C in response to user input (e.g. from user U1). The user may cause the system to prepare a number of draft project forecasts prior to selecting forecast 302C to be submitted for inclusion in a scenario. In the illustrated embodiment, the user has prepared draft forecasts 302A and 302B before finalizing forecast 302B as forecast 302C. Once forecast 302C has been submitted it is automatically included in submitted scenario 304. The system submits forecast 302C at step 303 and generates scenario 304 based, at least in part, on project forecast 302C. Scenario 304 may also incorporate one or more forecasts pertaining to projects not included in project forecast 302C. For example, scenario 304 may incorporate the most recently submitted project forecasts for each operating division across an enterprise (or across a portion of the enterprise).

In some circumstances, multiple forecasts 302A, 302B, 302C may be submitted (e.g. by different users) and may pertain to the same project. System 112 may, for example, generate scenario 304 based on the most recently-submitted forecast (e.g. 302C), and/or system 112 may generate multiple scenarios 304, each incorporating one of the multiple forecasts 302A, 302B, 302C, for review at step 307.

User U2 may review a submitted project forecast in submitted scenario 304 and approve it, reject it, or approve it with changes. This review may occur via, for example, approval system 122; changes (if any) may be provided by user U2 via approval system 122 and/or master scenario editor 126. If a project forecast from submitted scenario 304 is approved (with or without changes), the project forecast is added to approved scenario 306. Approved scenario 306 may correspond to master scenario 125 in FIG. 1.

Approved scenario 306 (and/or copies thereof) may be adjusted and/or optimized for various goals at step 305. For example, some project forecasts may be adjusted and/or optimized to achieve certain levels of reliability of the infrastructure. Some project forecasts may be adjusted and/or optimized to maximize safety to human beings. Some project forecasts may be adjusted and/or optimized to minimize or reduce costs attributable to unplanned failures. Some project forecasts may be optimized to come within a desired funding level. Any number of alternative scenarios may be prepared. In the illustrated embodiment, alternative scenarios 305A, 305B, and 305C (collectively scenarios 305) are shown. For example, alternative scenarios 305A, 305B, and 305C may correspond to scenarios which have been generated by optimizer 119 and/or by alternative scenario construction system 128 based on approved scenario 306.

In some embodiments, step 305 may involve generating alternative scenarios 305A, 305B, and 305C based on submitted scenario 304, which may occur prior to approval of approved scenario 306 at step 307. In such embodiments, user U2 may be provided with submitted scenario 304 and alternative scenarios 305A, 305B, and 305C at step 307. In such embodiments, step 307 may involve presenting a comparison of scenarios 304, 305A, 305B, and 305C to user U2. User U2 may approve one scenario from those presented, from which approved scenario 306 is generated.

In some embodiments, a number of different scenarios 305 contain the same project forecast. The required data storage is reduced by maintaining a record of all versions of each project forecast that are used by any scenarios 305. Different scenarios 305 may reference the applicable versions of the project forecasts they contain by, for example, using pointers to the memory locations of appropriate project forecast versions (as opposed to copying all of the data defining the project forecasts to be integrated into the scenarios 305). After appropriate adjustment and optimization, a user may select a scenario 305 to be an approved scenario 306. In the illustrated embodiment, scenario 305C is selected to be approved scenario 306.

A copy of the approved scenario 306 may be made and locked to provide a working plan or budget 308 at step 309. In some embodiments, the selected alternative 305 (in the illustrated embodiment, 305C) may also, or alternatively, be locked and kept as a record of a “requested scenario”. Locked scenarios are fixed and not subject to further editing. Locked scenarios may be stored in a different part of the memory of computer system 112 than scenarios which are not locked.

FIG. 4 is an entity relationship drawing illustrating a possible database structure for a database 400 which may be provided by computer system 112 to represent information regarding project forecasts, scenarios, and their different versions. Database 400 may, for example, be provided by database server 203.

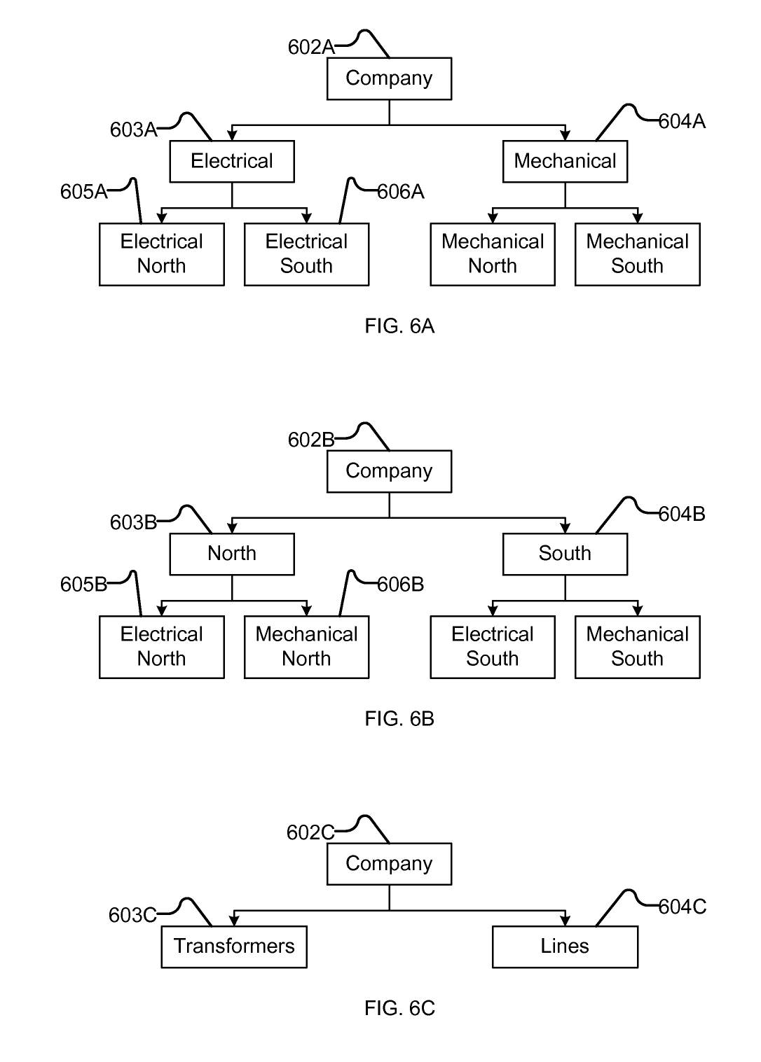

Computer system 112 may represent the overall structure of the enterprise's infrastructure as entries in portfolio table 414. Each entry of portfolio table 414 may define a category and/or hierarchy level which may be used to group components in an infrastructure (e.g. as discussed below with reference to FIG. 6). Each entry of portfolio table 414 may link to other entries of portfolio table 414 (e.g. such as parent elements in a hierarchy). Entries in portfolio table 414 may define which users may interact with them (e.g. by submitting forecasts which affect particular entries in portfolio table 414); such user permissions may be described in terms of roles. Elements of a portfolio may be subject to constraints, as described above; these constraints may be represented as entries in portfolio constraint item table 412. Entries in portfolio constraint item table 412 may link to entries in scenario table 430 to denote that particular scenarios are subject to particular constraints (e.g. a particular scenario may be subject to a constraint on capital expenditures, or may have a budget that is reduced 10% relative to a master budget scenario). Further, entries in portfolio table 414 may be associated with expenditures represented in expenditure table 440. Entries in portfolio table 414 may be mapped to entries in expenditure table 440 by way of entries in portfolio expenditure table 410.

Computer system 112 may represent users authorized to interact with the system as entries in users table 408 in database 400. Entries in the users table 408 may include, among other things, identifying information (such as first and last names, login information, etc.) and a representation of a user status which identifies of whether a particular user associated with the entry is authorized to submit forecasts (resulting in computer system 112 generating scenarios for approval) and/or approve scenarios. A users may have one or more supervising users, such as managers within the enterprise, who may be represented, for example, by a manager ID field in the entry corresponding to the user. Supervising users may be notified of forecast submissions and/or corresponding submitted scenarios. Supervising users may, for example, approve, reject, and/or modify forecast submissions prior to computer system 112 generating a scenario for approval. Supervising users may also, or alternatively, approve, project, and/or modify scenarios submitted as a consequence of the submission of forecasts (e.g. via approval system 122).

Computer system 112 may provide a forecast interface (e.g. via browser client pages 206, web client services 207, and/or APIs 208) whereby users may make changes to an approved scenario (e.g. represented in scenario table 430). Changes to a scenario may result in system 112 propagating updates to entries of forecast table 428 corresponding to the adjustments made. For example, changing a scenario so that certain projects have an earlier start date may result in corresponding adjustments to start dates being reflected in entries in forecast table 428, as described in greater detail below. Changes in an approved scenario may result in corresponding changes in draft forecasts (e.g. represented in distribution table 416 and/or alternative table 420).

Forecasts (as represented in forecast table 428 and/or distribution table 416) may be associated with one or more alternatives, as discussed above. Each alternative may correspond to an entry in alternative table 420. For example, entries of distribution table 416 may link to all generated alternatives in alternative table 420, and entries of forecast table 428 may link to all submitted alternatives in alternative table 420. Users may select between alternatives associated with a forecast by, for example, setting a selection flag (illustrated in FIG. 4 as IS_SELECTED_FLAG in alternative table 420). Selecting one entry of alternative table 420 may cause other alternatives associated with the same forecast to be deselected. Each entry of alternative table 420 may be associated with an alternative type, represented by an entry in alternative type table 422. Alternative types may reflect the type of optimization (e.g. optimizing for worker safety, optimizing for low cost, etc.) which resulted in the alternative being generated and/or may store parameters which are used when constructing an alternative. For example, certain alternative types may permit the start date of the forecast to be adjusted, whereas others may not. As another example, some alternative types may be “hidden”, so that alternatives of that type are not displayed to user U2. Computer system 112 may permit users to generate, view, and/or select alternatives at, for example, the forecasting interface, the scenario interface, and/or at an approval update interface.

An entry may be added to forecast change history table 424 which maps the submitted forecast in forecast table 428 to the new scenario entry in scenario table 430. Similarly, entries may be added to forecast change history table 424 corresponding to any changes to system scenarios. For example, each time a scenario is updated or submitted (e.g. by submitting a draft forecast), approved, and/or converted into a budget scenario, computer system 112 may add a corresponding entry to forecast change history table 424.

Entries in expenditure table 440 may represent actual past/current expenditures which are known (and may have associated entries in actual expenditures table 442) and/or anticipated future expenditures which may be based on forecasts, scenarios, and/or commitments (e.g. purchase orders). Each entry in expenditure table 440 may be associated with a timeframe (which may be represented as one or more date fields in expenditure table 440), one or more forecasts (which may be represented as entries in forecast table 428), a scenario (which may be represented as an entry in scenario table 430), and one or more purchase orders (which may be represented in purchase order spend table 444).

Computer system 112 may provide an actual expenditure interface (e.g. via browser client pages 206, web client services 207, and/or APIs 208) whereby users, other components of computer system 112, and/or other computer systems may record the actual expenditures spent to date in connection with a forecast, scenario, and/or portfolio. Actual expenditures may be recorded as entries in actual expenditures table 442. In some embodiments, when an actual expenditure is recorded in actuals table 442 and associated with an entry in expenditure table 440, computer system 112 may modify the forecast interface to take into account these past expenditures; for example, computer system 112 may only permit forecasts to be generated which are consistent with actual expenditures recorded in actual expenditures table 442. Computer system 112 may also, or alternatively, modify existing forecasts to reflect actual expenditures; such modifications may be reflected by entries in forecast change history table 424.

Computer system 112 may provide a commitments interface (e.g. via browser client pages 206, web client services 207, and/or APIs 208) whereby users, other components of computer system 112, and/or other computer systems may record future expenditures which have been committed to, but have not yet been actually spent. Such commitments may be represented as purchase orders recorded in purchase order table 446.

Each entry in purchase order table 446 may have associated expenditure information recorded in one or more entries in purchase order spend table 444 (each of which may be associated with an entry in expenditure table 440). Items in a given purchase order may be represented by entries in purchase order item table 448, and expenditures relating to individual purchase order items may bear presented by entries in purchase order item spend item table 452. Delivery information relating to particular purchase order items may be represented in purchase order item delivery table 450.

Computer system 112 may provide a loading and rates interface (e.g. via browser client pages 206, web client services 207, and/or APIs 208) whereby users, other components of computer system 112, and/or other computer systems may record changes to loadings (e.g. labor overhead) and/or rates (e.g. hourly cost of labor). Upon receiving updated loadings and rates information, computer system 112 may update one or more forecasts in distribution table 416, distribution item table 418 and/or forecast table 428 (and, in some embodiments, associated expenditure information in expenditure table 440) to take into account the effect of such changes. For example, in response to determining that the pay rate of utility pole maintenance workers has increased (or will increase in the future), system 112 may examine forecasts in distribution table 416 and forecast table 428 to determine whether each forecast is affected by the change. For affected forecasts (e.g. those relating to projects involving the maintenance of utility poles), the associated entry or entries in distribution item table 418 may be updated to reflect the increased rate. These changes may be propagated to expenditure table 440 entries associated with scenarios containing affected forecasts.

Computer system 112 may provide a scenario interface (e.g. via browser client pages 206, web client services 207, and/or APIs 208) whereby users may create, edit, and/or delete scenarios, create adjustments to scenarios, and/or copy forecasts between scenarios. As noted above, scenarios may be recorded as entries to scenario table 430. Scenarios may belong to expenditure groups, which may be represented as entries in scenario expenditure group table 436 and may map entries in scenario table 430 to entries in expenditure table 440. Scenario expenditure groups may be associated with entries in expenditure table 440, and may be further described by reference to entries in expenditure group table 438. Expenditure group table 438 entries may, for example, indicate whether expenditures are mandatory (“must do” items) or deferrable.

Computer system 112 may provide an approval update interface (e.g. via browser client pages 206, web client services 207, and/or APIs 208) whereby users may make changes to approved scenarios represented in scenario table 430. Changes to approved scenarios may result in corresponding changes to associated entries in forecast table 428, distribution table 416, distribution item table 418, and/or alternative table 420, according to the particular information that is adjusted (e.g. an adjustment to the start date of a project in a scenario may result in the START_DATE field of the associated entry in alternative table 420 being updated). As described above, changes to an approved scenario may result in a new entry in the forecast change history table 424.

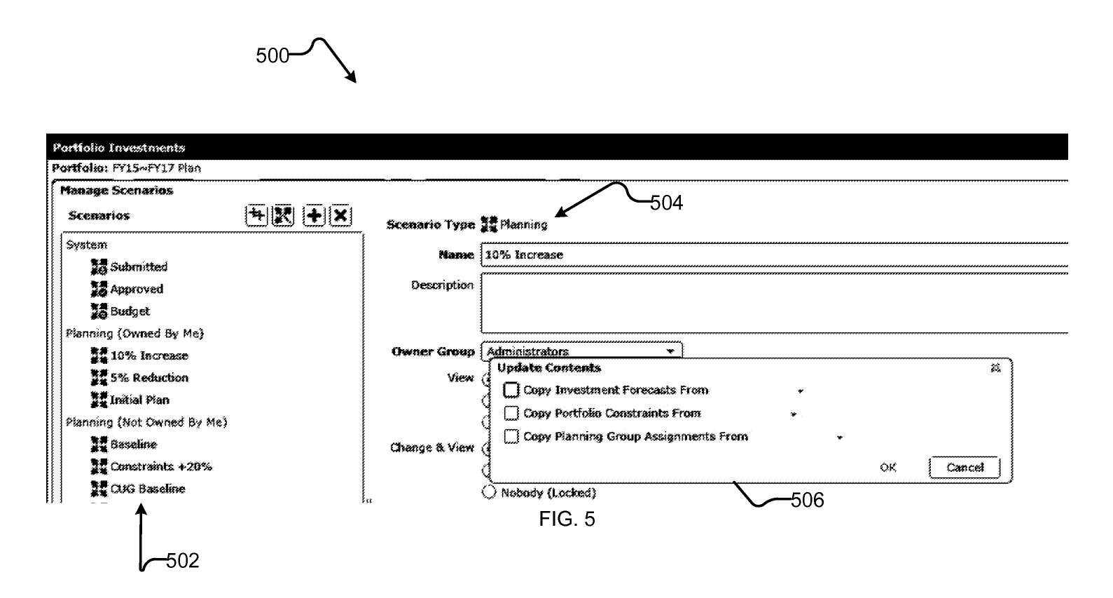

A user interface may be provided to allow users to view a range of scenarios. FIG. 5 shows an example of such a user interface 500. User interface 500 provides a view of scenarios 502 and a detailed view of a selected scenario 504. User interface 500 provides users with the ability to update the selected scenario 504 via an update interface 506. Scenarios 502 are organized into groups, such as a system group (i.e. groups of scenarios generated by computer system 112), a planning group consisting of scenarios owned by the current user, and the planning group consisting of scenarios not owned by the current user.

Some embodiments provide a range of different ways to organize forecasts into hierarchies. For example, FIGS. 6A, 6B, and 6C illustrate various hierarchies that may be used to organize the various projects included in a scenario. Each of the depicted hierarchies is a different way of visualizing the same example underlying scenario. For example, in FIG. 6A, viewing the portfolio at the company level (i.e. at company category 602A) would include in the portfolio all projects corresponding to the company (which, in some embodiments, comprises all of the projects represented by computer system 112). The next level of the hierarchy divides into electrical and mechanical categories 603A, 604A, respectively. Selecting category 603A will show all projects in the current scenario associated with an electrical part of the infrastructure, whereas viewing mechanical category 604A will show only those projects associated with the mechanical aspects of the infrastructure. A third tier of the hierarchy divides electrical category 603A into electrical north and electrical south subcategories 605A, 606A, respectively.

Similarly, FIG. 6B shows an alternative hierarchy in which the north and south divisions of the company form the second tier of the hierarchy, namely north category 603B and south category 604B. North category 603B is further subdivided into electrical and mechanical categories 605B and 606B, respectively. An alternative hierarchy shown in FIG. 6C has transformer and line categories 603C, 604C, corresponding to projects relating to transformers and lines, respectively.

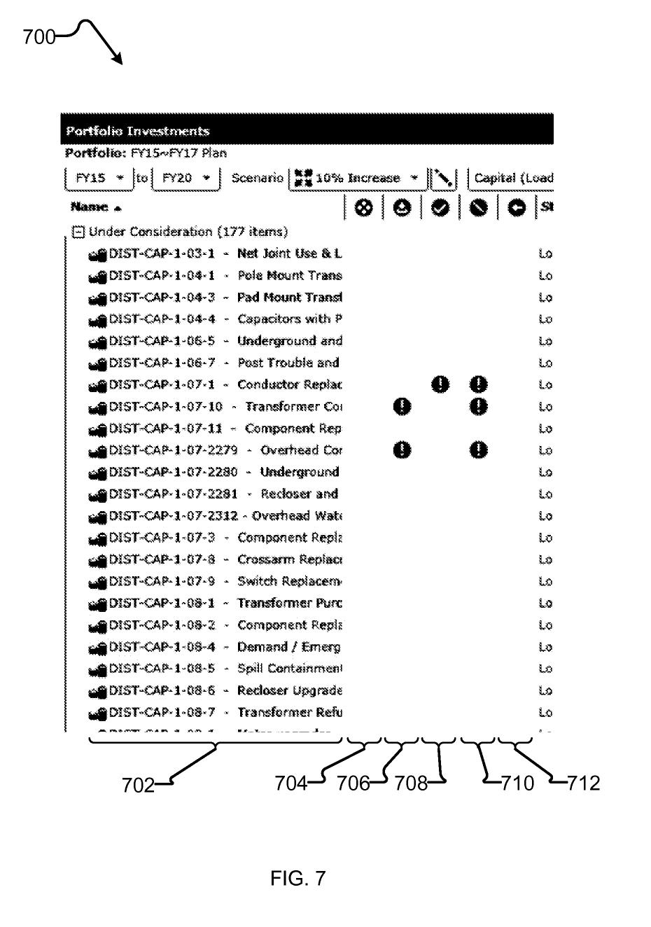

FIG. 7 illustrates a view 700 that may be provided of an example scenario. This view communicates to users whether there is a more recent version of a project forecast for a given project and whether a project forecast in the selected scenario (e.g., in the illustrated view 700, the “10% Increase” scenario) differs from the version of that project forecast in the approved scenario. In the depicted example, column 702 shows each project by name. Column 704 indicates whether or not a forecast corresponding to the project has an associated adjustment in the selected scenario (e.g. as indicated by an entry in forecast table 428 with a link in the field UNADJUSTED_FORECAST_ID to another entry in forecast table 428).

Column 706 indicates whether a project forecast corresponding to the project has been submitted (but not yet approved) more recently than the corresponding forecast in the selected scenario (e.g. as indicated by a comparison of the FORECAST_ID for the selected scenario and the submitted scenario in the scenario forecast table 426, and/or by comparing the CREATED_DATE fields for the linked forecasts). Column 708 indicates whether or not the forecast associated with a given project in the selected scenario is different than the approved forecast for that project (e.g. as indicated by a comparison of the FORECAST_ID fields for the selected scenario and the approved scenario in scenario forecast table 426).

Column 710 indicates whether or not the project has an edit which has not yet been submitted. Column 712 indicates whether or not the project has an actual expenditure which has not yet been submitted. Further information may be shown in additional (or alternative) columns, such as determining the total expenditure associated with the project, determining the commitments made with respect to project, determining a project start and/or end date, and/or other information.

Project forecasts for individual projects may be updated from another scenario, copied to another scenario, or modified either by making manual adjustments or by making automatic adjustments, for example by running optimizer 119.

The submitted scenario may be dynamically adjusted. Each time a new forecast for a project is submitted the new project forecast replaces the previous version of that project forecast in the submitted scenario.

A range of individuals may be automatically notified regarding changes in the status of submitted forecasts. These individuals may include one or more of:
A user U1 who submits a project forecast;
A user US responsible for considering whether or not to approve the project forecast;
One or more users responsible for infrastructure components to which the project forecast relates;
One or more users responsible for implementing projects corresponding to the submitted project forecast.

In some embodiments computer system 112 allows such users or others who have appropriate permissions to annotate and/or comment on submitted project forecasts. Such comments and/or annotations may be stored by computer system 112 and associated with the corresponding project forecast. This functionality facilitates workflows in which:
When a project forecast is submitted, a number of users are automatically notified, the specific users who are notified may be variable as among project forecasts and determined, for example, based on what infrastructure components are affected by the project forecast and/or the identity of the user U1 who submitted the project forecast.
A user U2 may review the comments and/or annotations when considering whether or not to approve the submitted project forecast.
If the submitted project forecast is approved then user U1 and perhaps other users may be automatically notified of this change in status.
If user U2 modifies the submitted project forecast, either at the time of approving the submitted project forecast or later then user U1 and perhaps other users will be automatically notified of the modification.
User U2 may optionally associate comments and/or annotations with the project forecast. User U1 or others may review those comments/annotations.

A facility for comments and annotations provided by system 112 can improve communication between users and provide context for project forecasts and any modifications to the project forecasts. Maintaining those comments/annotations in system 112 in association with versions of project forecasts ensures that the comments/annotations will be available to authorized users.

Computer system 112 may perform one or more of the following steps in order to display information to a user (e.g. via view 700):
a. In response to a user selecting a portfolio, computer system 112 may determine which projects belong to a selected portfolio by comparing entries in portfolio table 414 and portfolio expenditure table 410. These projects may be displayed in column 702.
b. Computer system 112 may determine which scenarios the user has authorization to access by comparing entries in scenario table 430 and users table 408. In some embodiments, only these projects are shown in column 702. In some embodiments, these projects are shown in column 702 separately from projects which the user does not have authorization to access. The user may select a scenario which they have authorization to access from column 702.
c. Computer system 112 may determine the aggregated expenditure amount for each project by comparing entries in forecast table 428, scenario forecast table 46, forecast distribution table 432, and forecast distribution item table 434. Aggregated expenditure amounts may be determined over one or more time ranges (e.g. by month or by year), account types (which may be provided by user U1 at the forecast-drafting stage), and/or other factors.
d. Computer system 112 may determine the total expenditure amount across all projects in the portfolio. For example, computer system 112 may perform step c (described above) on each entry in forecast table 428 associated with the currently-approved scenario as are presented in scenario table 430. Aggregated expenditure amounts may be determined over one or more time ranges (e.g. by month or by year), account types, and/or other factors.
e. Computer system 112 may determine the aggregated expenditure amount corresponding to actual expenditures and/or commitments (e.g. purchase orders) for each project by comparing entries in forecast table 428, scenario forecast table 46, forecast distribution table 432, and forecast distribution item table 434 and cross-referencing those entries with entries in actual expenditure table 442, purchase order spend table 444, purchase order table 446, purchase order item table 448, and/or purchase order item spend item table 452. Aggregated expenditure amounts may be determined over one or more time ranges (e.g. by month or by year), account types, and/or other factors.
f. Computer system 112 may retrieve the constraints on the portfolio by comparing entries in portfolio table 414 and portfolio constraint item table 412. Computer system 112 may provide a comparison of the aggregated portfolio expenditures calculated in step d and the committed expenditures calculated in step e, with the constraints defined for the portfolio. For example, if portfolio constraint item table 412 has an entry indicating a maximum budget of $100 million over a certain time frame (e.g. in the year 2017) and the aggregated expected cost of all forecasts in forecast table 428 is $105 million then the budget constraint and the forecast cost may be shown to the user for comparison.
g. Computer system 112 may determine, for each project, whether the forecast associated with the project is associated with any adjustments. Computer system 112 may compare entries from scenario forecast table 426 and forecast table 428 in order to determine whether a given scenario has adjustments corresponding to the project to be displayed. For example, adjusted forecasts may be stored as entries in forecast table 428, and those entries may link to their corresponding pre-adjustment forecast entries in forecast table 428.
h. Computer system 112 may determine, for each project, whether there is a more recent submitted forecast than the one in the selected scenario. Computer system 112 may compare entries from scenario forecast table 426 (e.g. by comparing FORECAST_ID fields in two entries of scenario forecast table 426), forecast table 428, and/or alternative table 420 to determine whether a more recent forecast has been submitted. If a new forecast in forecast table 428 is associated with a project in the selected scenario, or if the original forecast in forecast table 428 is associated with a different alternative in alternative table 420 then was originally approved, then computer system 112 may determine that a more recent submitted forecast is available.
i. Computer system 112 may determine whether the forecast corresponding to a project in the selected scenario is the same as the forecast for that project in the approved scenario. Computer system 112 may compare entries from the scenario forecast table 426 and forecast table 428 to determine this (e.g. by comparing the FORECAST_ID fields of two entries of scenario forecast table 426 to determine whether the two scenarios are associated with the same forecasts).
j. Computer system 112 may determine whether a project has edits which have not yet been submitted by comparing entries from scenario forecast table 426, forecast table 428, alternative table 420, and distribution table 416. Information in alternative table 420 and/or distribution table 416 which differs from information in scenario forecast table 426 and/or forecast table 428 may correspond to edits which have not yet been submitted. In some embodiments, system 112 uses triggers to flag fields which have been changed instead of, or in addition to, querying for changes each time a list of edits is desired. Such triggers may cause each edit to be recorded (e.g. in an edit table and/or in a data structure in a memory of system 112) for relatively easy access.
k. Computer system 112 may determine whether a project has actual expenditures which have not yet been submitted by comparing entries in expenditure table 440 and actual expenditure table 442. As with edits to projects, described above, changes to actuals may be flagged via triggers and recorded in other tables and/or memory.

In many embodiments system 112 interacts dynamically with the infrastructure of an organization to create a combination which maintains the infrastructure at a desired level and avoids situations where the condition of infrastructure components will fall below a desired level (thereby potentially adversely impacting one or more of the reliability, safety, or efficiency of the infrastructure) and there is not time to remedy the situation before one or more infrastructure components degrades to the point that such adverse effects become undesirably probable. System 112 receives feedback from the infrastructure both in terms of information regarding the conditions of infrastructure components (which may be inferred from factors such as sensor readings, physical inspection of the components, tests of the components, age of the components, usage of the components etc.). Such condition information together with information regarding how the condition of infrastructure components tends to evolve with time may contribute significantly to the selection of project forecasts that are submitted.

In some embodiments, computer system 112 includes or cooperates with an inventory system that maintains records regarding the components of an infrastructure which include information relevant to the current condition of those components. A user U1 may draw on information in such a database to propose project forecasts relating to projects that would replace, upgrade or refurbish selected infrastructure components. In some embodiments, step 302 may comprise generating automatically one or more draft project forecasts.

For example, an optimizer may be applied to prioritize projects for replacing, refurbishing or upgrading infrastructure components subject to constraints such as limiting the failure risk of components and/or limiting the available budget. The output of such an optimizer may yield a selection of draft project forecasts for consideration by user U1. Environment 114 may optionally include or provide access to such an optimizer. The optimizer may run over a subset of all of the components of the infrastructure for which user U1 has responsibility. In some embodiments the optimizer includes a system as described in PCT patent application publication WO2013/082724 which is hereby incorporated herein by reference for all purposes. The optimizer could also or in the alternative comprise another type of optimizer such as a linear solver. Various optimizers are commercially available.

At step 302 a user may also apply other tools for identifying projects for which project forecasts should be generated. For example, tool may be provided which identifies infrastructure components for which the failure risk is expected to increase past a threshold value within some time frame unless this situation is addressed by a project. Such a tool may optionally filter out infrastructure components for which there is a submitted or approved project forecast which would address the situation.

System 112 may also receive feedback from the infrastructure by way of input to an optimizer at step 305. The optimizer may, for example, take into account future failure risks for infrastructure components (which may be based on information derived from the infrastructure itself such as the factors above which are related to the probability of failure of an infrastructure component) and the role of the infrastructure component in the infrastructure (which affects the severity of consequences if the infrastructure component fails).

As a result of the above, the projects approved through use of system 112 respond directly to the dynamically changing condition of the infrastructure. The output of system 112 then affects the infrastructure by providing projects which can be executed to alter the condition of the infrastructure so as to maintain the infrastructure at a desired level of reliability, safety, efficiency. In some embodiments system 112 incorporates or integrates with a project management system. The project management system may be automatically populated with projects based on approved project forecasts. This may be done periodically or, in some embodiments a certain time prior to the start date for a project proposed in an approved project forecast.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in an enterprise computer system may implement methods as described herein by executing software instructions in a program memory or memories accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

While processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A method for planning projects for maintaining an infrastructure, the method implemented by a computer system and comprising:
a. receiving a plurality of submissions of new versions of project forecasts, each of the project forecasts associated with a project to replace, upgrade and/or refurbish an infrastructure component, the submissions initiated by one or more first users of the computer system;
b. presenting a user interface that provides a second user with options including: rejecting the new version of the project forecast and accepting the new version of the project forecast for each of the submitted new versions;
c. incorporating the accepted new versions into a master scenario.

2. The method according to claim 1 comprising, for one or more of the submitted new versions, determining that one or more modifications have been applied to a corresponding current version of the project forecast in the master scenario and, for the one or more of the submitted new versions, providing the second user with the option to incorporate the new project forecast as modified by the one or more modifications in the master scenario in place of the current version of the project forecast.

3. The method according to claim 1 comprising receiving from the second user a modification to one of the accepted new versions, applying the modification to the one of the accepted new versions in the master scenario and automatically notifying the first user of the modification.

4. The method according to claim 1 comprising automatically updating a submitted scenario to include the submitted new versions in place of corresponding current versions of the project forecasts.

5. The method according to claim 4 comprising displaying a comparison of the submitted scenario and the master scenario.

6. The method according to claim 5 wherein the same version of one or more project forecasts are present in both the master scenario and the submitted scenario, the computer system comprises a single copy of the same version, and the submitted scenario and the master scenario each comprise a pointer to the single copy of the same version.

7. The method according to claim 1 comprising automatically notifying the second user on receipt of the submitted new versions.

8. The method according to claim 1 comprising storing a copy of the master scenario as a budget scenario and locking the budget scenario against changes.

9. The method according to claim 1 comprising by the computer system performing an optimization on the master scenario, the optimization yielding modifications to one or more of the project forecasts in the master scenario.

10. The method according to claim 9 comprising automatically notifying the one or more first users of the computer system about any of the modifications applied to project forecasts submitted by the one or more first users of the computer system.

11. The method according to claim 1 wherein one of the plurality of new versions includes a plurality of alternatives, each of the plurality of alternatives specifying a different action to perform on the corresponding infrastructure component, the one of the new versions having a first one of the alternatives selected as an active alternative.

12. The method according to claim 11 comprising receiving from the second user and applying a modification to the one of the plurality of new versions in the master scenario, the modification comprising selecting a second one of the alternatives different from the first one of the alternatives as the active alternative.

13. A method for planning projects for maintaining an infrastructure, the method implemented by a computer system and comprising:
a. receiving submission initiated by a first user of a new version of a project forecast associated with a project to replace, upgrade and/or refurbish an infrastructure component;
b. determining that one or more modifications have been applied to a current version of the project forecast in a master scenario;
c. In response to input from a second user, applying the one or more modifications to the new project forecast and incorporating the new project forecast as modified by the one or more modifications in the master scenario in place of the current version of the project forecast.

14. The method according to claim 13 comprising automatically notifying the second user on receipt of the new version of the project forecast.

15. The method according to claim 13 comprising automatically including the new version of the project forecast in a submitted scenario distinct from the master scenario.

16. The method according to claim 13 comprising storing a copy of the master scenario as a budget scenario.

17. The method according to claim 13 comprising automatically creating in a project management system a project corresponding to the new version of the project forecast.

18. The method according to claim 13 comprising automatically notifying a plurality of users of the received submission.

19. The method according to claim 13 comprising receiving by way of the computer system comments relating to the new version of the project forecast and associating the comments with the new version of the project forecast.

20. The method according to claim 13 comprising presenting a user interface that provides the second user with options including: rejecting the new version of the project forecast, accepting the new version of the project forecast without modification, and accepting the new version of the project forecast as modified by the one or more modifications.

21. The method according to claim 13 further comprising applying an optimization to the master scenario, the optimization yielding a further modification to the new version of the project forecast, and applying the further modification to the new version of the project forecast.

22. A system useful for planning projects for maintaining an infrastructure, the system comprising a plurality of first user environments in data communication with a database, the database storing records corresponding to each of a plurality of project forecasts, the project forecasts each specifying a project to replace, upgrade and/or refurbish an infrastructure component, the database comprising associations grouping project forecasts into scenarios, the scenarios including at least a master scenario;
a. Each of the first user environments comprising a data processor configured to generate submissions of new versions of the project forecasts;
b. An approval system connected to receive the submissions, the approval system presenting a user interface that provides a second user with options for processing the submissions including: rejecting the new version of the project forecast and accepting the new version of the project forecast for each of the submitted new versions, the approval system configured to incorporate accepted ones of the new versions into the master scenario.

23. The system according to claim 22 comprising a master scenario editor providing tools for the second user to modify the project forecasts in the master scenario.

24. The system according to claim 22 wherein the scenarios comprise a submitted scenario that is automatically updated by the system to contain a most-recently-submitted version of each one of the project forecasts.

25. The system according to claim 23 comprising a display displaying a comparison of the submitted scenario and the master scenario.
